(19) United States
(12) Patent Application Publication
(10) Pub. No.: US 2002/0120453 A1
(43) Pub. Date: Aug. 29, 2002

(54) Electronic voice date book

(76) Inventors: Hsi-Che Lee, Taipei (TW); Tung-Hsing Pan, Taipei (TW); Mei-Jiuan Chan, Taipei (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/790,875

(22) Filed: Feb. 23, 2001

(51) Int. Cl. G10L 11/00

(52) U.S. Cl. 704/275

(57) ABSTRACT

An electronic voice date book comprising a CPU (central processing unit) connected with a keypad, a LCD (liquid crystal display) screen, a voice IC, memory, and a driver. The voice IC is connected to a microphone and a speaker, and the driver is connected to a vibrator. To record an event, users assign an alarm through the keypad and leave a voice message through the microphone. The message is saved to the voice IC, and the alarm setting is saved to the memory. The driver activates the vibrator at the preset time, and the speaker simultaneously plays the message to remind the users of the event.

### BACKGROUND OF THE INVENTION

I. Field of the Invention

This invention relates generally to an electronic voice date book and, more specifically, to an electronic voice date book that saves voice messages in a voice IC (integrated circuit) and alarm settings in the memory. At the preset time, a driver activates a vibrator to give a soundless alarm, and a speaker plays the recorded message to remind the users of the event.

II. Description of the Prior Art

Heretofore, it is known to construct a date book in terms of a calendar printed on paper, on which users have to write down messages for events. With a date book of such construction, users have to constantly check on the written messages for upcoming events. When users are occupied with numerous assignments at work, they might easily forget or have no time to check the calendar and thus miss the event, suffering from unpredicted loss.

It is also known to maintain a date book with the assistance of a secretary. The typical duty of a secretary is to record and arrange events/meetings for users. However, the salary of a secretary is not affordable for everyone, and the working hours of secretaries are usually limited.

The present invention improves on the heretofore known date book maintenance by providing an electronic voice date book. The voice date book is composed of a CPU (central processing unit), which is connected with a keypad, a LCD (liquid crystal display) screen, a voice IC, memory, and a driver. The voice IC is also connected to a microphone and a speaker, and the driver is linked to a vibrator.

To record an event, users set up an alarm through the keypad and input the message through the microphone. The message is to be recorded in the voice IC, and the alarm setting is saved in the memory. According to the alarm setting, the driver activates the vibrator, and the speaker plays the recorded message to remind users of the given event.

### SUMMARY OF THE INVENTION

It is therefore a primary object of the invention to provide an electronic voice date book comprising a CPU connected to a voice IC, memory, and a driver. Users can assign an alarm for a given event through the keypad and record the message for the event by speaking to the microphone. The vibrator, activated by the driver, triggers according to the preset alarm, and the speaker simultaneously plays the recorded message.

### BRIEF DESCRIPTION OF THE DRAWINGS

FIG. 1 is a circuit diagram of the present invention;

FIG. 2 is a circuit diagram (I) of a further embodiment of the circuit diagram of the present invention;

FIG. 3 is a circuit diagram (II) of a further embodiment of the circuit diagram of the present invention;

FIG. 4 is a circuit diagram (III) of another embodiment of the circuit diagram of the present invention;

FIG. 5 is a flowchart for program setting (I) in accordance with the present invention;

FIG. 6 is another flowchart for program setting (II) in accordance with the present invention;

FIG. 7 is a flowchart for event searching and deleting in accordance with the present invention;

FIG. 8 is a flowchart for the main program in accordance with the present invention.

### DESCRIPTION OF THE PREFERRED EMBODIMENT

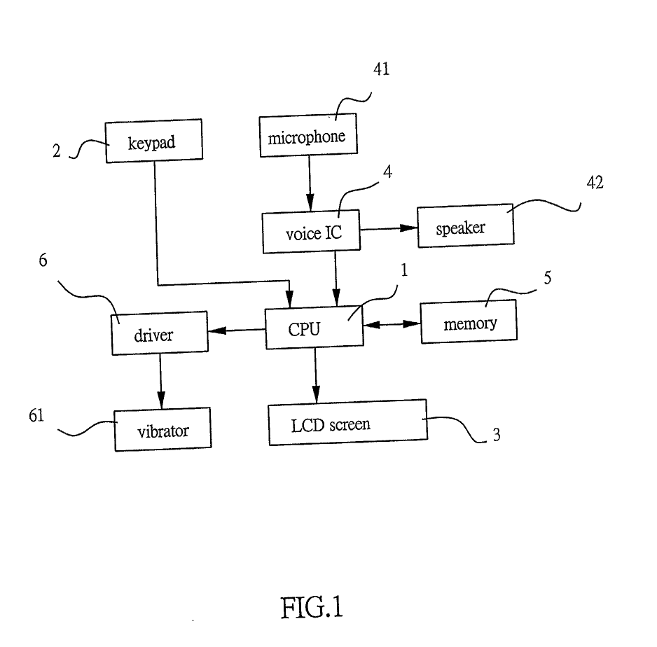

Referring to FIG. 1, the present invention is composed of a CPU 1, which is connected to a keypad 2, a LCD screen 3, voice IC 4, memory 5, and a driver 6. The functions of each component are described below:

The CPU 1 controls the internal circuit of the present invention. The keypad 2 is used for setting alarms as well as entering commands. The LCD screen 3 displays digital information stored in the date book or entered by users. The voice IC 4 is linked to a microphone 41 and a speaker 42. Voice messages are to be received through the microphone 41, stored in the voice IC 4, and played through the speaker 42.

The memory 5 stores the time setting input from the keypad 2. The driver 6 is connected to a vibrator 61 and activates the vibrator 61 at the preset time to remind users of a specific event.

Users can use the keypad 2 to enter commands of setting, deleting, resetting, etc. The LCD screen 3 displays the information about time settings so that users can easily operate on the keypad to assign an alarm. Further, users can record the message for an event by speaking through the microphone 41. The voice message will be converted to digital signals and then saved in the voice IC 4.

Once the setting is completed, the CPU 1 monitors the time setting saved in the memory 5 and would signal the driver 6 and the voice IC 4 at the preset time. In turn, the driver 6 would activate the vibrator 61, and the speaker 42 would play the previously recorded messages to remind users of the event.

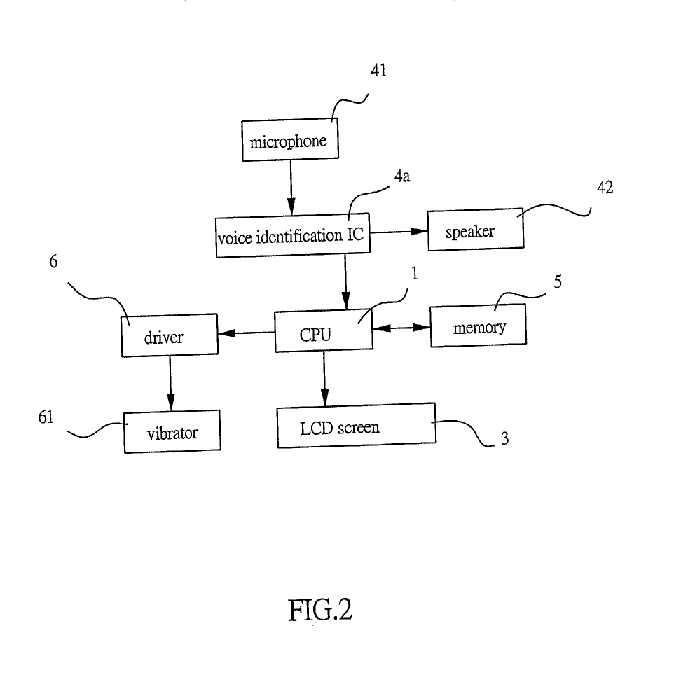

Referring to FIG. 2 that shows an application of the present invention, the voice IC 4 can be modified into a voice identification IC 4a, which is also connected to a microphone 41 and a speaker 42. The microphone 41 receives the input of voice messages and/or commands, which is then converted to digital signals by the voice identification IC 4a. With the voice identification IC 4a, users can input messages by voices. After being input into the device, the voice message is turned into words that is displayed on the LCD screen 3.

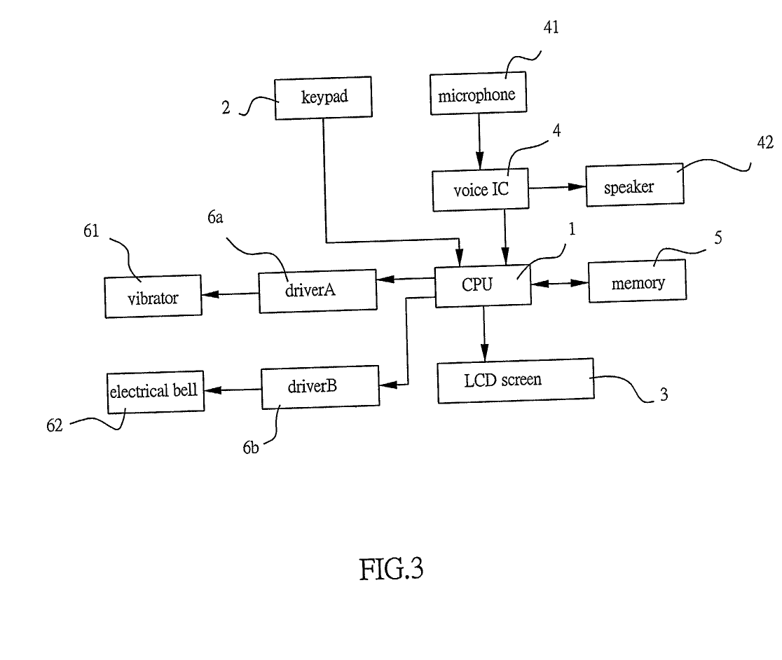

Referring to FIG. 3, the CPU 1 can be connected to two separate drivers 6a, 6b, with the driver 6a linked to a vibrator 61 and the driver 6b linked to an electrical bell 62. Users can preset the alarm mode by choosing between vibrant (soundless) and audible signals.

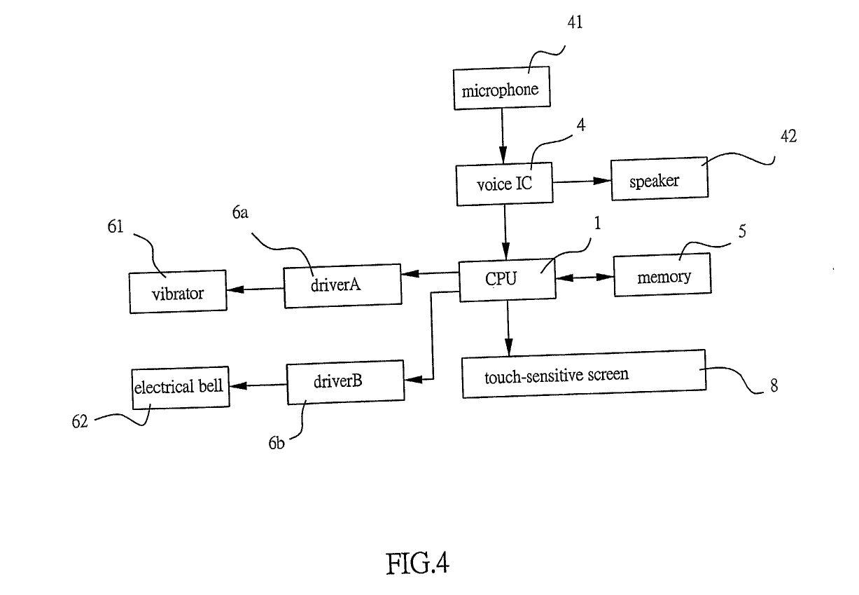

Referring to FIG. 4, the functions of the keypad 2 and the LCD screen 3 can be combined by applying a touch-sensitive screen 8. Users can enter commands by tapping or clicking elements on the screen, which displays the commands as well as other information of the date book.

As another application of the present invention, users can assign a vibrant or audible alarm as a reminder without recording any messages for a specific event,. Further, the present invention can be applied to a variety of electronic devices, such as watches, pagers, mobile phones, and PDAs (personal digital assistant).

To record an event in the voice date book, users have to preset an alarm and record a message for the event.

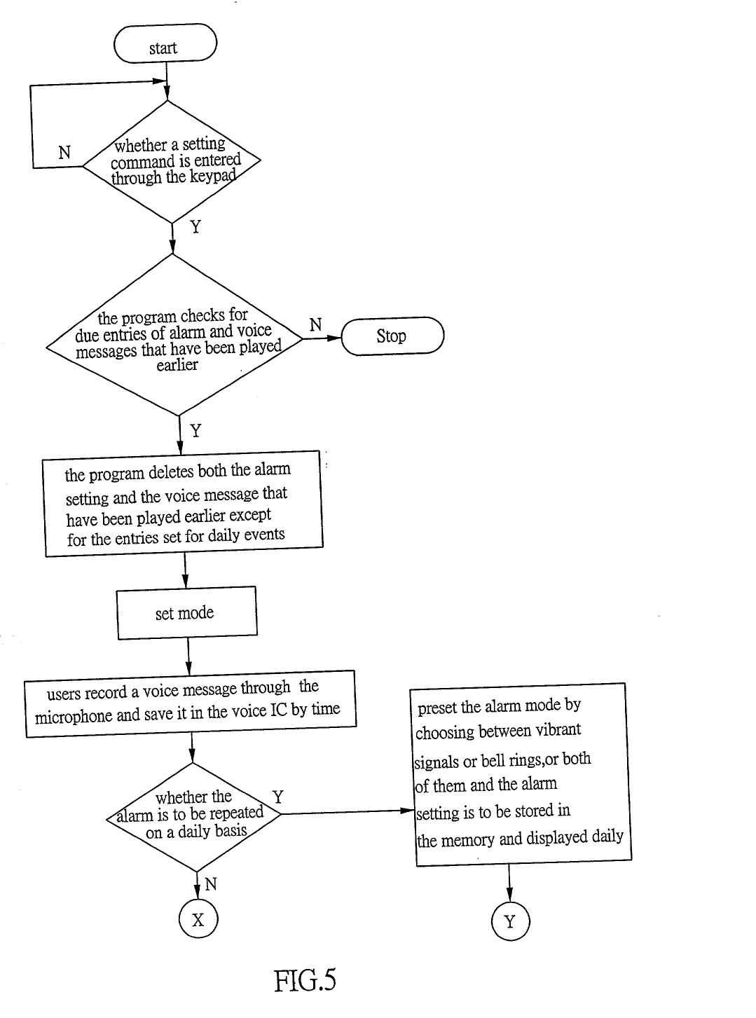

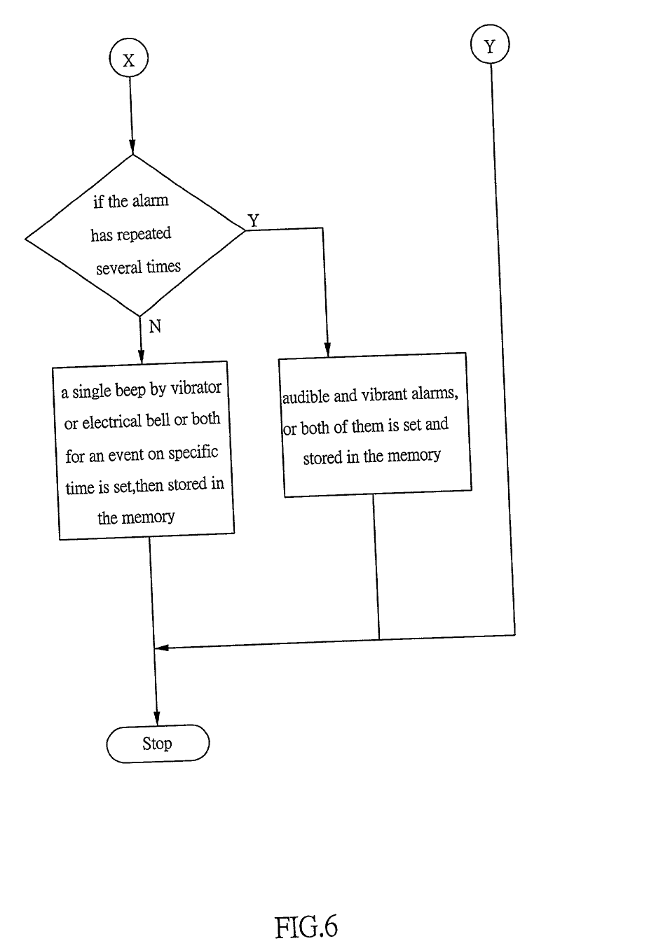

As can be seen in FIG. 5 and FIG. 6, the program first detects whether a setting command is entered through the keypad 2. If yes, the program first checks for due entries of alarm and voice message that have been played earlier. If there is any due entry of alarm and voice message, the program deletes both the alarm setting and the voice message that have been played earlier except for the entries set for daily events. If there are no due entries, the program stops.

The program precedes to the presetting mode, in which users record a voice message for an event through the microphone 41 and save it in the voice IC 4 by time. Users then assign an alarm for the event by indicating whether the alarm is to be repeated on a daily basis and at the same time choosing between audible and vibrant (soundless) alarms, or both of them. The alarm setting is to be stored in the memory 5 and displayed daily. Users have to decide how frequently the alarm is to trigger (several times) and how the alarm is to trigger (i.e., vibrant signals and/or bell rings, a single beep). The alarm setting is to be stored in the memory 5.

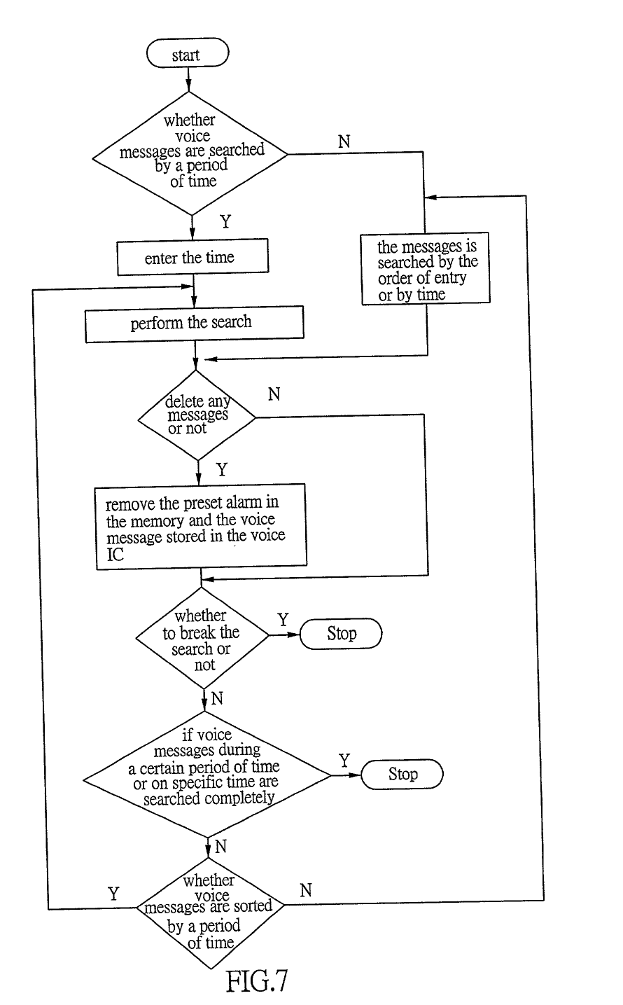

As the presetting completes, users can perform commands of searching and deleting, as shown in FIG. 7. If users prefer to check for an event by time, they enter the time and perform the search. If users do not enter a period of time, they would view the messages by the order of entry. Afterwards, users can choose to delete any entry, removing the preset alarm in the memory 5 and the voice message stored in the voice IC 4. If they don't want to delete any messages, they can choose to break the search. If not, they can continue to search voice message during a certain period of time or on specific time until the messages are searched completely. If users finish searching and deleting, they can escape from the search and deletion mode. They can also reselect searching events during a period of time.

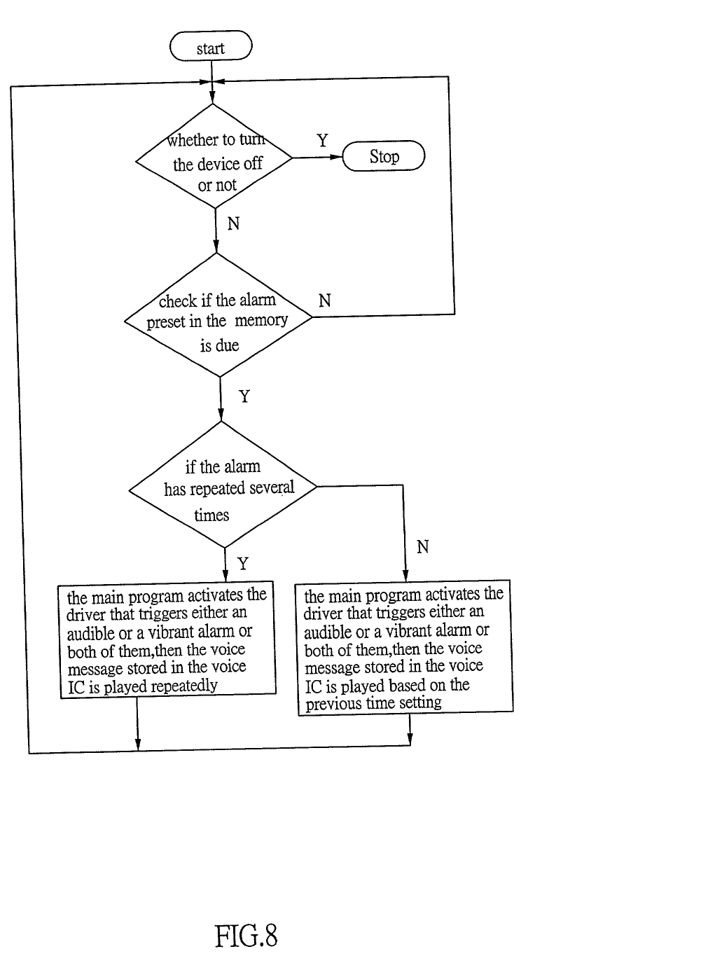

Referring to FIG. 8, once the presetting is completed, the date book enters the main program. The main program monitors the alarm presets stored in the memory 5. The main program activates the driver that triggers either an audible or a vibrant alarm, or both of them, based on the previous time setting.

While a preferred embodiment of the invention has been shown and described in detail, it will be readily understood and appreciated that numerous omissions, changes and additions may be made without departing from the spirit and scope of the invention.

What is claimed is:

1. An electronic voice date book comprising:
a CPU (central processing unit ) controlling the internal circuit;
a keypad being connected to said CPU, used for input of time settings and commands;
a LCD screen being connected to said CPU for displaying input of commands and output of the date book;
a voice IC being connected to said CPU, a microphone and a speaker for storing voice messages; said microphone for receiving voice messages; said speaker for playing voice messages;
memory, connected to said CPU, storing input of time presets entered from the keypad; and
driver, connected to said CPU and a vibrator, activates the vibrator at the time according to the alarm setting.

2. The electronic voice date book recited in claim 1, wherein said voice IC is modified into a voice identification IC, which is also connected to said microphone and said speaker, able to recognize voice messages as well as other verbal commands.

3. The electronic voice date book recited in claim 1, wherein said CPU is linked to two separate drivers, with each driver connected to alarms of either a vibrator or an electrical bell, between which the alarm modes can be switched through program setting.

4. The electronic voice date book recited in claim 1, wherein said keypad and said LCD screen can be replaced by a touch-sensitive LCD screen.
